(19) United States
(12) Patent Application Publication
(10) Pub. No.: US 2003/0051042 A1
(43) Pub. Date: Mar. 13, 2003

(54) Load balancing method and system for allocation of service requests on a network

(75) Inventor: Eiichi Tazoe, Tokyo (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/242,105

(22) Filed: Sep. 12, 2002

(30) Foreign Application Priority Data
Sep. 13, 2001 (JP) 2001-278227

(51) Int. Cl. G06F 15/16; G06F 15/173

(52) U.S. Cl. 709/229; 709/223

(57) ABSTRACT

An allocation server connected to a network is provided. When a client transmits a service request to the allocation server, the allocation server selects a process server from a table, and transmits to the client selection information for the selected process server. Thereafter, all processing is performed by the client and the selected process server.

### BACKGROUND OF THE INVENTION

The present invention relates to a load balancing technique for allocation of service requests on a network to handle concentration of service requests and reduce congestion.

When a user uses a computer connected to a network, generally, the user operates a client computer to transmit a service request to a server computer via the network. Thereafter, the server performs processing in response to the service request, and transmits results to the client. Recently, since computer networks, especially the Internet, have become so popular, the number of network users has increased dramatically, and the service request transmission volume (the traffic) has grown explosively. As a result, the requests may concentrate at a specific server, and the traffic at that server may exceed the server's processing capacity. In this case, the server may be overloaded and the processing of service requests may be delayed, or in the worst case, performing the processing may be impossible. As one solution for this problem, load balancing methods are available that provide for the allocation of clients' service requests to a plurality of servers, instead of depending on a single server to handle all of them. Using a load balancing method, the number of service requests to be handled by each of servers can be reduced, and delays in the processing of the service requests can be also reduced.

One of conventional load balancing methods is a DNS round robin method that implements a system such as is shown in FIG. 7. In short, a DNS round robin method is a load balancing method whereby, on a TCP/IP network such as the Internet, a table 60 in which information is entered for a plurality of process servers (servers that actually provide services when service requests are received) is prepared for a DNS (Domain Name System) server that provides as a service the identification of identifying an IP address based on a host name, and whereby, when a service request is received from a client, a process server entered in the table 60 is allocated as the service provider. Thus, when a user uses a client computer 10 to designate a URL (Uniform Resource Locator; represents the address location for an entity on a TCP/IP network) and to submit a service request via a network 20, the inquiry is routed to a nearby DNS server 30. The DNS server 30 selects one of process servers 50a to 50n using a list of the process servers 50a to 50n entered in the table 60 and allocates an IP address therefor. Thereafter, the selected process server performs the requested processing and transmits the results obtained to the client computer 10.

Another conventional load balancing method is a dispatcher method implemented by a system such as is shown in FIG. 8. According to the dispatcher method, a dispatcher server 70 that dispatches (allocates) all service requests is located among process servers 50a to 50n. When a user operates a client computer 10 to transmit a service request to the dispatcher server 70. A DNS server 30 performs an IP address conversion, and the client computer 10 accesses the dispatcher server 70. In response to receiving a service request, the dispatcher server 70 selects one of the process servers 50a to 50n, and allocates the service request to the selected process server. The selected process server then performs the required processing and transmits the results obtained to the client computer 10 via the dispatcher server 70.

However, the following problems have arisen in the use of the conventional load balancing methods. That is, according to the DNS round robin method, since all the DNS tables present on the network must be rewritten, a considerably extended period of time is required to complete the rewriting of all the tables. Thus, it is difficult to quickly cope with a change in the configuration of the process server, and the allocation of a specific service request may be missed. For example, when a new process server is added, a client using a DNS to which the information for this expansion has not yet been registered would not be able to use the new process server until the required registration has been completed for the DNS.

And as for the dispatcher method, since all traffic passes through the dispatcher server, the processing capacity of the dispatcher server can become a major traffic disrupting bottleneck. Therefore, in order to avoid this undesirable feature, the processing capacity of the dispatcher server must be expanded, and during this process, the system tends to become overly large and complicated. Further unwanted results are that the hardware and software investment for the facility is increased, and security problems, such as security holes, tend to occur because the processing contents are complicated.

It is, therefore, one objective of the present invention to provide an effective, simple load balancing technique that does not require a large facility investment.

### SUMMARY OF THE INVENTION

An overview of the invention will now be presented. To achieve the above objective, a load balancing method for a computer system including a client, an allocation server and a plurality of process servers, for allocation of service requests comprises the steps of: issuing, at a client, a service request to an allocation server at a designated address; in response to receiving the service request, selecting, at the allocation server, one of the plurality of process servers to handle the service request; and transmitting, at the allocation server, the selection information of the selected process server to said client through said network. After the selection information has been transmitted by the allocation server, the selected process server provides a service for the client.

Further, according to this method, one or more address locations of entities on a network and processes for each of the address locations are entered in a table. The allocation server extracts an address location of an entity on the network from the service request, and determines a process to be performed for the address location by comparing the extracted address location with the address locations entered in a table, and performs the process.

According to this method, the network can be a TCP/IP network, the address location can be a URL, the service request to be transmitted by the client can be a request conforming to the HTTP protocol, and the selection information can be an HTTP response to the request. The allocation server can extract a URL from a GET sentence included in the service request, and can transmit the selection information to the client via the network in accordance with HTTP 302.

According to this method, the table that the allocation server refers to need only be rewritten when the configuration of the system is changed. Therefore, a load balancing method can be provided that can cope more rapidly with a change than can the DNS round robin method. In addition, since the allocation server is accessed only when the first inquiry is transmitted, the dispatcher server, unlike in the dispatcher method, will not become a processing bottleneck.

Further, since only simple processing is required, this method can be easily mounted and little program development is required for its implementation. Such simplification contributes to the prevention of the occurrence of potential bugs (e.g. security holes) that are due to human error. Furthermore, this simplified method also contributes to apparatus downsizing (compactness), and enables the employment of an inexpensive system configuration.

The present invention can be provided not only as the above method, but also as a computer system or an allocation server. Further, HTTP can be HTTPS, a protocol having a security function.

### BRIEF DESCRIPTION OF THE DRAWINGS

FIG. 1 is a schematic diagram showing an example system configuration using a load balancing method according to the present invention.

FIG. 2 is a flowchart showing the processing performed for the load balancing method according to a first embodiment of the present invention.

FIG. 3 is a diagram showing the contents of a table that an allocation server uses for the load balancing method according to the first embodiment of the invention.

FIG. 4 is a flowchart showing the processing performed for a load balancing method according to a second embodiment of the present invention.

FIG. 5 is a diagram showing the contents of a service request transmitted by a client according to the load balancing method of the second embodiment of the invention.

FIG. 6 is a diagram showing the contents of a table that an allocation server uses for the load balancing method according to the second embodiment.

FIG. 7 is a conceptual diagram showing an example system configuration that uses a load balancing method provided by a conventional DNS round robin method.

FIG. 8 is a conceptual diagram showing an example system configuration that uses a load balancing method provided by a conventional dispatcher method.

### DETAILED DESCRIPTION OF THE PREFERRED EMBODIMENT

The preferred embodiments of the present invention will now be described in detail while referring to the accompanying drawings. It should be noted, however, that the present invention is not limited to these embodiments, and that many other embodiments can be used to carry out the invention. It should also be noted that throughout the embodiments the same reference numerals are used to denote corresponding or identical components.

In the following embodiments, mainly a method or a system will be explained. As will be apparent to one having ordinary skill in the art, however, the present invention can also be provided as a computer-usable program. The present invention can be provided using hardware, software or a combination of them, and for this purpose, a program can be recorded on an arbitrary computer-readable storage medium, such as a hard disk, a CD-ROM, an optical storage device or a magnetic storage device.

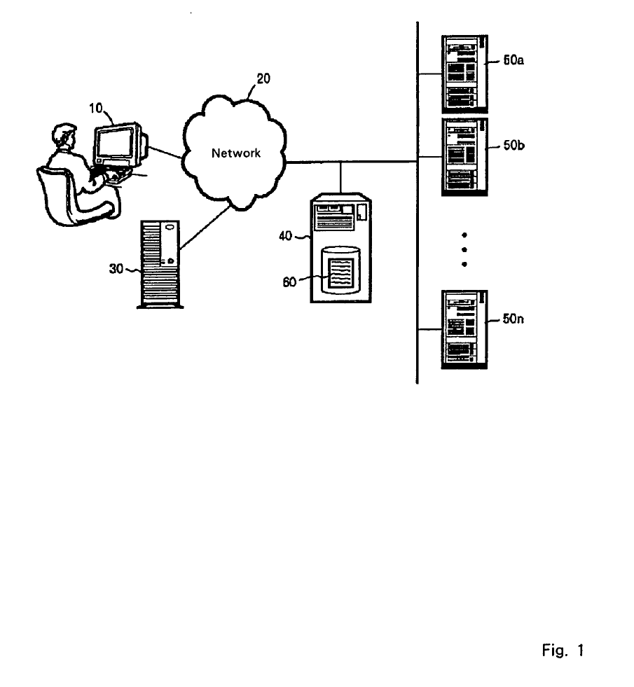

FIG. 1 is a diagram showing an example system configuration using a method according to the invention for the allocation of service requests. The system for the present invention comprises: a client computer 10, a network 20, a DNS server 30, an allocation server 40, including a table 60, and a plurality of process servers 50a to 50n.

The client computer 10 is a well known terminal that can be connected to the Internet, and that can appropriately be implemented by one having ordinary skill in the art. Further, a connection between the client 10 and the network 20 can be established via an ISP (Internet Service provider), by using a dial-up connection technique. The connection of a client 10 to an ISP is not limited to a dial-up connection, and an always-on connection using a dedicated line, an ADSL (Asymmetric Digital Subscriber Line) or a CATV (Cable Television) connection, can be used.

The network 20 is a communication channel for connecting the allocation server 40 and the process servers 50a to 50n, and can be provided, for example, as the Internet. As is well known, the network 20, which is the Internet, uses TCP/IP (Transmission Control Protocol/Internet Protocol) to connect systems. For the network 20, global IP addresses or local IP addresses, is used to specify systems that are to be interconnected.

The DNS server 30 generally provides a service for identifying an IP address based on a host name. In the embodiments, when the client 10 transmits a service request to the allocation server 40, or when one of the process servers 50a to 50n actually provides a service for the client 10, the DNS server 30 provides as a service the identification of an IP address based on the host name.

The allocation server 40 holds the table 60 in which information concerning the process servers 50a to 50n is entered. In response to receiving a service request from the client 10, the allocation server 40 refers to the table 60 to select the process server 50a to 50n that will actually provide the requested service, and transmits selection information for the selected process server to the client. In the embodiments, it should be noted that the host name of the allocation server 40 is “www.ibm.com”, and that, as is shown in FIG. 3, a list of the host names of the process servers 50a to 50n, which will be described later, is entered in the table 60.

The process servers 50a to 50n are those for actually handling a service request transmitted by the client computer 10. Specifically, in the embodiments, a service request from the client computer 10 is transmitted to the allocation server 40 by using the DNS server 30 via the network 20. In response to receiving the service request, the allocation server 40 selects from among the process servers 50a to 50n the server that will actually handle the service request. The allocation server 40 then transmits to the client computer 10 selection information relevant to the process server that is selected, so that an association between the client computer 10 and the process server is established for the processing of the service request. Thereafter, the client computer 10 communicates with the selected process server 50, and receives the results obtained for the service request. For the embodiments of the invention, assume that the host names of the process servers 50a to 50n are “www-1.ibm.com”, “www-2.ibm.com”, . . . and “www-n.ibm.com”.

For the client computer 10, the DNS server 30, the allocation server 40 and the process servers 50a to 50n, an example hardware configuration is a computer system that includes ordinary hardware entities, such as a central processing unit (CPU), a main memory (RAM), a nonvolatile memory (ROM), a co-processor, a cache memory, an input/output controller (I/O), an external memory, such as a hard disk drive, and communication means for connecting to a network such as the Internet. The computer systems that may be used include a variety of types, such as personal computers, workstations and mainframe computers, and compact computers such as PDAs (Personal Data Assistants).

It is preferable that the client computer 10, the DNS server 30, the allocation server 40 and the process servers 50a to 50n include software, such as an operating system and middleware, for utilizing the above described hardware entities.

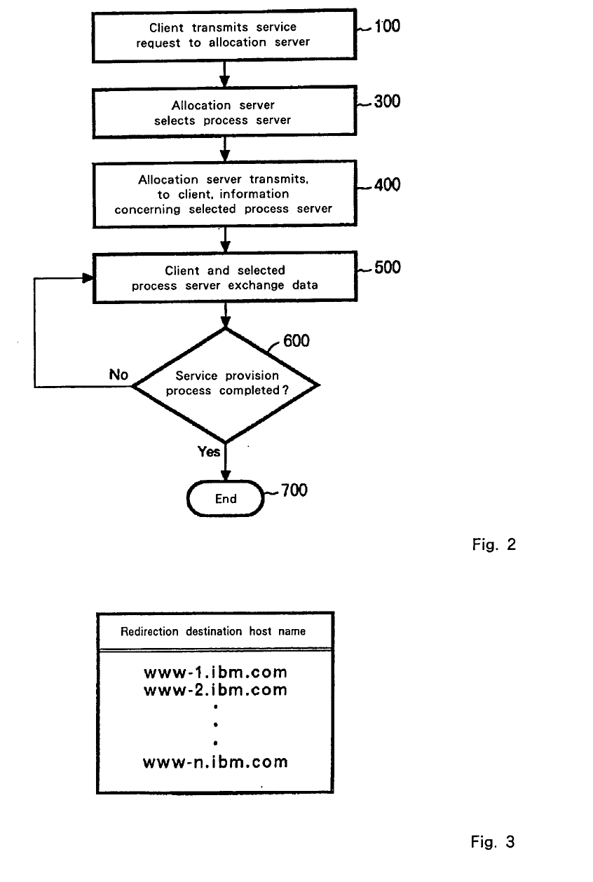

A first embodiment of the present invention will now be described. FIG. 2 is a flowchart showing the processing according to the first embodiment for allocating service requests.

In the first embodiment, at step 100, the client computer 10 designates the URL of the allocation server 40 and transmits a service request thereto. In this embodiment, the protocol used for issuing a service request is HTTP. As is well known to one having ordinary skill in the art, HTTP 1.1 is the protocol specified in RFC 2616, which is managed by the IETF (Internet Engineering Task Force). Of course, the present invention can also be implemented by using another version of HTTP, such as HTTP 1.0. The DNS server 30 executes the IP address conversion of the service request transmitted by the client computer 10, and transmits the service request to the allocation server 40.

At step 300, in response to receiving the service request from the client computer 10, the allocation server 40 uses the table 60 to select the process server that processes the service request. For the selection of the process server, the host names on the list in the table may be allocated in order, or the allocation server 40 may be provided a function, for measuring the congestion level at each process server 50, that it uses to allocate the service request to a process server having a low congestion level. Since in the above process an analysis of the contents of the service request using HTTP is not required, performing the process is extremely simple.

At step 400, the allocation server 40 transmits to the client computer 10 the selection information for the process server that is selected at step 300. At this time, HTTP 302 (redirection) can be used. It should be noted that HTTP 302 is used to change (redirect) the destination of a service request transmitted for a specific server and to reroute the request to another server. A detailed description of this procedure is given in chapter 10.3.3 of RFC 2616 (HTTP 1.1), described above.

At step 500, the client computer 10 accesses the selected process server by using the received selection information. For this access, the user of the client computer 10 can use an automatic redirection function, available with an HTTP compatible browser, if HTTP 302 is used at step 400.

Program control then advances to step 600. And until the service provision process is completed, program control is shifted between steps 600 and 500, along the arrow path No, while the client computer 10 and the allocated process server repetitively exchange data (no detailed explanation for the contents of the specific process will be given). When the service provision process is completed, program control advances from step 600 along the arrow path Yes to step 700. The processing is thereafter terminated.

According to the first embodiment, in response to the reception of a service request from the client computer 10, the allocation server 40 selects a process server from the table 60, and transmits to the client computer 10 selection information for the selected process server 50. The processing thereafter is performed between the client computer 10 and the allocated process server 50. In this embodiment almost no load is imposed on the allocation server 40; the allocation server 40 merely introduces the process server to the client computer 10. Further, since the process required for the introduction is very simple with little load imposed, the allocation server with an extremely simple configuration can be implemented.

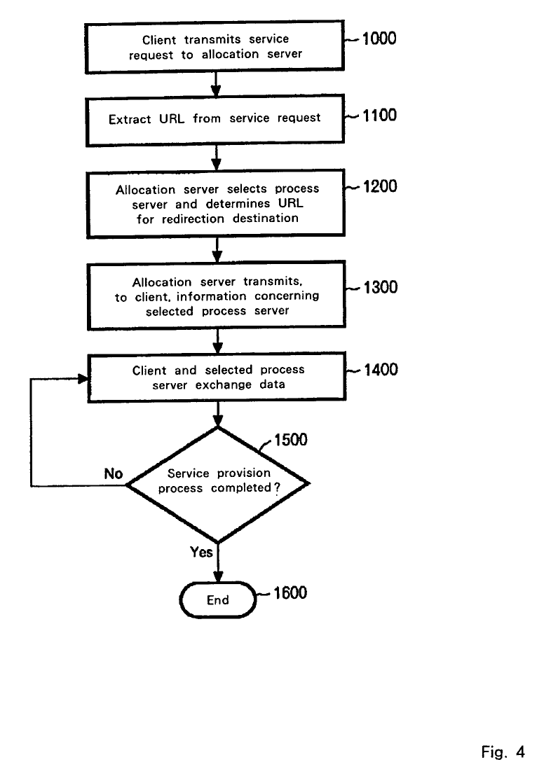

A second embodiment of the present invention will now be described. In the second embodiment, additional information is entered in a table 60, and is used to provide an expansion function for an allocation server 40. FIG. 4 is a diagram showing an example of the processing performed to allocate service requests.

In the second embodiment, at step 1000, a client computer 10 transmits a service request to an allocation server 40. The same method can be used to perform this process as is used at step 100 in the first embodiment.

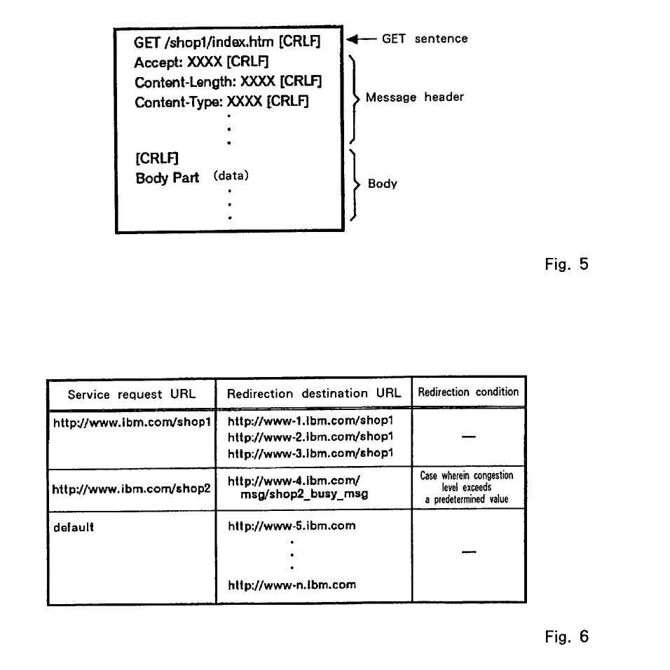

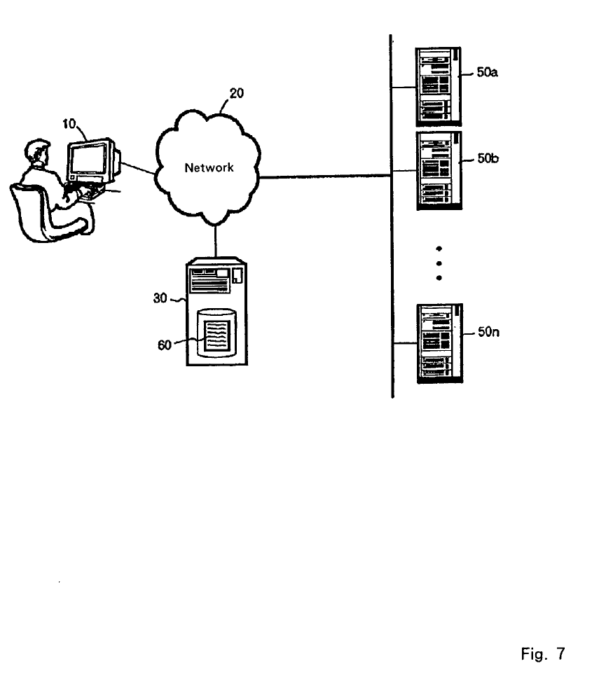

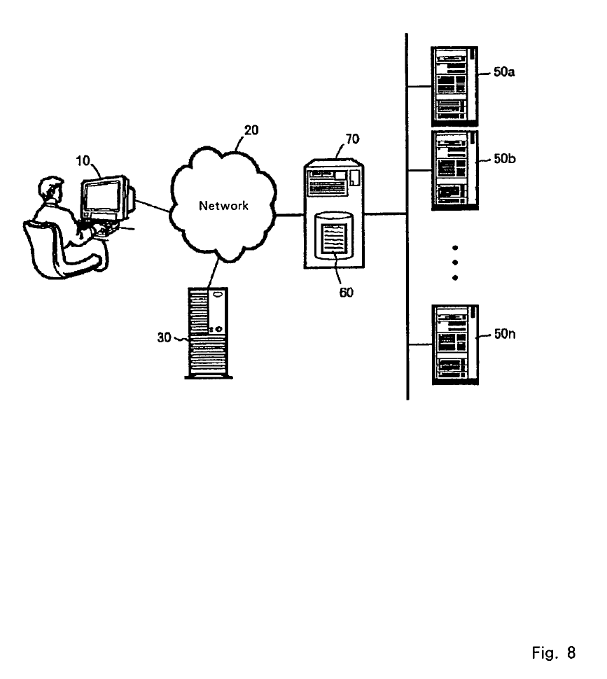

At step 1100, the allocation server 40 analyzes the service request received from the client computer 10, and extracts the URL from which the service is requested. FIG. 5 is a diagram showing the contents of an HTTP service request. The allocation server 40 obtains a URL from a GET sentence (a sentence representing a command for obtaining data at the location of an argument) in the service request. The URL can be easily obtained from the host name and the argument contained in the GET sentence. In this embodiment, since the host name of the allocation server 40 is “www.ibm.com” and the argument included in the GET sentence is “/shop1/index.h-tm”, the obtained URL is “http://www.ibm.com/shopl/index.h-tm”. It should be noted that lines other than the GET sentence (a message header and a message body) are not required for the following process, and can be abandoned. As a result, the above process can be very simple.

At step 1200, the allocation server 40 uses the URL obtained at step 1100 and the table 60, within which additional data is included, to determine the process server that can handle a service request and the process to be performed (process contents). FIG. 6 is a diagram showing an example table 60 in which additional information is entered. In the first embodiment, only the host names of the process servers are included in the table 60, while in the second embodiment, URLs extracted from service requests, redirection destination URLs and redirection conditions (process contents) are also included.

In the example in FIG. 6, in the first column in the table 60 it is declared that, when the URL extracted from the service request is below “http://www.ibm.com/shopl”, a service is to be allocated to three servers, “http://www-1.ibm.com”, “http://www-2.ibm.com” and “http://www-3.ibm.com”. Then, in the second column, it is declared that, when the URL extracted from the service request is entered below “http://www.ibm.com/shop2”, and the congestion level is high, redirection is to be performed for a file in which “http://www-4.ibm.com/msg/shop2-busy-msg.htm” is included, and the file is to be displayed as a message. And in the third column, it is declared that in a case other than those declared in the first and second columns, a service request process is allocated to “http://www-5.ibm.com” to “http://www-n.ibm.com”. In order to carry out the declaration in the second column, means for measuring the congestion level of each process server is required for the allocation server 40, and since this technique is well known, one having ordinary skill in the art can easily mount this function in the allocation server 40.

Since at step 1100 the URL of the service request in FIG. 5 is determined as “http://www.ibm.com/shopl/index.htm”, it is ascertained at step 1200 that this corresponds to the case presented in the first column of the table 60 in FIG. 6, and one of the designated servers “http://www-1.ibm.com”, “http://www-2.ibm.com” and “http://www-3.ibm.com” is selected as the process server that will handle the service request.

At step 1300, information relative to the process server selected at step 1200 is transmitted to the client computer 10. This transmission can be performed using the same method as is used for first embodiment, including the use of HTTP 302. When HTTP 302 is used, a user can use an automatic redirection function by using an HTTP compatible browser.

Program control then advances to step 1500, and as in the first embodiment, until the provision of a service is completed, program control repetitively returns to step 1400 from step 1500 along the arrow path No, while the client computer 10 and the allocated process server repeatedly exchange data. When the provision of the service is completed, program control advances from step 1500 to step 1600 along the arrow path Yes, and the processing is thereafter terminated.

According to the second embodiment, a table 60 is prepared in which URLs, corresponding redirection destination URLs and redirection conditions are entered. Then, in response to the reception of a service request from the client computer 10, the allocation server 40 extracts a URL from the service request, a process server (redirection destination URL) is selected based on the table 60, in accordance with the extracted URL and the redirection condition, and information relative to the selected process server is transmitted to the client computer 10. The processing thereafter is performed between the client computer 10 and the allocated process server. With this arrangement, the process performed is still simple with only a small load being imposed, and the allocation server 40 can be implemented with a simple configuration.

The above explanation of the preferred embodiments has been given merely to provide a description of the invention; not all possible embodiments are covered, and the present invention is not limited to the forms that have been disclosed. For example, while in the embodiments different computers are used for an allocation server and a process server, an allocation server may also serve as a process server. Further, a table has been prepared by using only one file; however, multiple files may be used, or the table may not be stored in the allocation server but in another server or a storage device, and may be referred to via a network. Furthermore, according to the above disclosure, the many modifications and variations are available. It should also be noted that the scope of the present invention is not limited to the detailed description that has been given, and is defined by the claims of the invention. The production and the use of the embodiments of the invention are fully explained by the specifications, the examples and the data described above, and many other embodiments of the invention can be implemented without departing from the spirit and the scope of the invention.

According to the invention, without an large facility investment, service requests can be effectively allocated only by additionally providing an allocation server having a simple configuration to a conventional system. Since a table the allocation server refers to need only be rewritten to cope with a change in the system configuration, a load balancing method can be provided that can cope more rapidly with a change than can the DNS round robin method. In addition, since the allocation server is accessed only at the time an inquiry is first received, when a process requested by a client requires N pages, the number of messages handled by the allocation server is only 1/N of the number required by the dispatcher method, and unlike the dispatcher method, a dispatcher server can not, overall, become a bottleneck. Furthermore, since additional information is entered in the table and since a corresponding function is provided for the allocation server, a more superior load balancing method can be provided. Moreover, since an allocation server having a very simple configuration can be provided, the allocation server can be easily mounted, and to provide a program, only a small amount of development is required. Such simplicity contributes to the prevention of potential bugs (security holes, etc.) that are due to human errors, and provides a robust system that can withstand an external attack. Further, the simplicity of the configuration also contributes to downsizing of an apparatus (compactness), so that an inexpensive system configuration can be obtained.

What is claimed is:

1. In a computer system including a client, a plurality of process servers and an allocation server, a load balancing method for allocation of service requests from said client, the method comprising the steps of:
receiving, at said allocation server, a service request from said client through a network;
in response to receiving said service request, selecting, at said allocation server, one of said plurality of process servers to handle said service request by referring to a table including information of said plurality of process servers; and
transmitting, at said allocation server, the selection information of said selected process server to said client through said network,
wherein said selected process server provides a service for said client after said selection information has been transmitted by said allocation server.

2. The method according to claim 1, wherein said network is a TCP/IP network, said service request to be transmitted by said client is a request conforming to the HTTP protocol, and said selection information is an HTTP response to said request.

3. The method according to claim 2, wherein said response is implemented as HTTP 302.

4. The method according to claim 1, wherein said service request is transmitted by designating an address location of an entity on said network; wherein one or more address locations of entities on a network and processes for each of the address locations are entered in said table; wherein said allocation server extracts an address location of an entity on said network from said service request, and determines a process to be performed for said address location by comparing said extracted address location with said address locations entered in a table, and performs said process.

5. The method according to claim 4, wherein said network is a TCP/IP network, said address location is a URL, said service request to be transmitted by said client is a request conforming to the HTTP protocol, and said selection information is an HTTP response to said request; and wherein said allocation server extracts a URL from a GET sentence included in said service request, and transmits said selection information to said client via said network in accordance with HTTP 302.

6. A computer system including an allocation server and a plurality of process servers, comprising:
a plurality of process servers for performing a service process for a service request transmitted from a client via a network; and
an allocation server for, in response to receiving said service request, selecting one of said plurality of process servers to handle said service request by referring to a table including information of said plurality of process servers, and for transmitting the selection information of said selected process server to said client through said network;
wherein said selected process server provides a service for said client after said selection information has been transmitted by said allocation server.

7. The computer system according to claim 6, wherein said network is a TCP/IP network, said service request to be transmitted by said client is a request conforming to the HTTP protocol, and said selection information is an HTTP response to said request.

8. The computer system according to claim 7, wherein said response is implemented as HTTP 302.

9. The computer system according to claim 6, wherein said service request is transmitted by designating an address location of an entity on said network; wherein one or more address locations of entities on a network and processes for each of the address locations are entered in said table; wherein said allocation server extracts an address location of an entity on said network from said service request, and determines a process to be performed for said address location by comparing said extracted address location with said address locations entered in a table, and performs said process.

10. The computer system according to claim 9, wherein said network is a TCP/IP network, said address location is a URL, said service request to be transmitted by said client is a request conforming to the HTTP protocol, and said selection information is an HTTP response to said request; and wherein said allocation server extracts a URL from a GET sentence included in said service request, and transmits said selection information to said client via said network in accordance with HTTP 302.

11. An allocation server, connected to a network to which a client and a plurality of process servers are connected, comprising:
means for receiving a service request from said client through said network;
means for, in response to receiving said service request, selecting one of said plurality of process servers to handle said service request by referring to a table including information of said plurality of process servers; and
means for transmitting the selection information of said selected process server to said client through said network,
wherein said selected process server provides a service for said client after said selection information has been transmitted by said allocation server.

12. The allocation server according to claim 11, wherein said network is a TCP/IP network, said service request to be transmitted by said client is a request conforming to the HTTP protocol, and said selection information is an HTTP response to said request.

13. The allocation server according to claim 12, wherein said response is implemented as HTTP 302.

14. The allocation server according to claim 11, wherein said service request is transmitted by designating an address location of an entity on said network; wherein one or more address locations of entities on a network and processes for each of the address locations are entered in said table; wherein said allocation server extracts an address location of an entity on said network from said service request, and determines a process to be performed for said address location by comparing said extracted address location with said address locations entered in a table, and performs said process.

15. The allocation server according to claim 14, wherein said network is a TCP/IP network, said address location is a URL, said service request to be transmitted by said client is a request conforming to the HTTP protocol, and said selection information is an HTTP response to said request; and wherein said allocation server extracts a URL from a GET sentence included in said service request, and transmits said selection information to said client via said network in accordance with HTTP 302.
